(19) United States
(12) Patent Application Publication
(10) Pub. No.: US 2015/0012661 A1
(43) Pub. Date: Jan. 8, 2015

(54) Media Processing in a Content Delivery Network

(71) Applicant: Twin Technologies, Inc., Altamont, NY (US)

(72) Inventor: Benjamin Elmore, Altamont, NY (US)

(73) Assignee: TWIN TECHNOLOGIES, INC., Altamont, NY (US)

(21) Appl. No.: 14/325,316

(22) Filed: Jul. 7, 2014

Related U.S. Application Data
(60) Provisional application No. 61/843,415, filed on Jul. 7, 2013.
(60) Provisional application No. 61/843,414, filed on Jul. 7, 2013.

(51) Int. Cl. H04L 29/06

(52) U.S. Cl. CPC H04L 65/601
USPC 709/231

(57) ABSTRACT

An intermediary node, such as an edge node, in a content delivery network (CDN) intercepts a media transmission en-route to a client device. The media transmission and a client profile are analyzed to determine if the media requires additional processing to provide a customized media format before the media is routed to the client device. During message delivery in a CDN, an intermediary edge node intercepts a request for media content from a client device and determines a customized content format based on the request and the client profile before routing the request to an appropriate server.

### CROSS-REFERENCE TO RELATED APPLICATIONS

This application claims benefit to U.S. Application No. 61/843,414 filed Jul. 7, 2013, and U.S. Application No. 61/843,415 filed Jul. 7, 2013, the entire contents of which are incorporated herein by reference.

### BACKGROUND OF THE INVENTION

I. Field of the Invention

The present invention relates to a system and a method for a content delivery network (CDN), and in particular, to systems and methods for managing resources for content distribution.

II. Description of the Related Art

Just as different varieties of content delivery services have evolved over time, several different network architectures have also evolved for deploying these services. These architectures range from fully centralized (e.g., using one or more centralized servers to provide content to all consumers) to fully distributed (e.g., multiple copies of content distributed on servers very close to the customer premises, at the “edge” of the distribution network)

Distributed computer systems are well-known in the prior art. One such distributed computer system is a CDN that is operated and managed by a service provider. The service provider typically provides the service on behalf of third parties. A distributed system of this type typically refers to a collection of autonomous computers linked by a network or networks, together with the software, systems, protocols and techniques designed to facilitate various services, such as content delivery or the support of out-sourced site infrastructure.

The CDN shifts the delivery of content from a centralized site to multiple highly distributed sites and overcomes many issues associated with network size, congestion, and failures. For example, a CDN employs a collection of content servers and associated control mechanisms to offload work from Website origin servers by delivering content on their behalf to end users. A well-managed CDN that serves some or all of the contents of a site's Web pages reduces the customer's infrastructure costs while enhancing the end-users' browsing experience.

In a CDN, multiple cache servers are deployed at different locations. Servers are connected in a certain network topology and cooperate to resolve requests sent from clients. More specifically, cache servers collaboratively make storage decisions and route content requests inside the cache hierarchy. This requires a carefully designed placement strategy for cached content, along with a specific request routing mechanism. In a conventional caching network that supports web content delivery, the perceived service quality can be improved with collaborative caching by minimizing the end-to-end latency of data packets. However, the problem becomes even more challenging when the collaborative caching mechanism is used to aid massive content delivery, such as streaming video.

In operation, the conventional CDN uses a request routing mechanism to locate a CDN content server close to the client to serve each request directed to the CDN, where the notion of “close” is based, in part, on evaluating results of network traffic tests. Since digital media objects may be found in a wide variety of forms, the distribution, processing, and routing of digital media objects requires different rules.

For example, a digital image object may have any of a number of image resolutions, color depths, compression methods, compression ratios, and file formats. A digital video object may be encoded using any of a number of codecs and compression standards. A digital audio file may have any number of bit rates and sampling frequencies and may similarly be encoded using any of a number of encoding and compression standards. The diversity of digital media standards may be represented by the format, which dictates how the media object is encoded, and the transport protocol, which determines how the media can be accessed. Due to the wide range of client device capabilities, the media format delivered to a client device is often not optimal for ingestion by the client device. Thus, digital media properties should be considered by the CDN to ensure that media delivered to each client can be properly ingested and that unnecessarily large media files are not consuming network resources.

Furthermore, current CDN services lack several fundamental capabilities demanded by users, including personalization of content (i.e., adaptation to the preferences and attributes of specific users or groups of users); portability of a given content session across different devices; and access to an aggregation of different content types, from commercial content (such as news feeds, movies, television shows, and sporting events) to user-generated content (e.g., online video and photo services, music playlists, blogs, and user reviews). Additionally, subscribers also desire to integrate other services with their access to content, such as chat, text/SMS, voice communications, Twitter, and social networking websites.

As the volume and diversity of CDN traffic grows, content delivery providers increasingly need to customize and deliver content in ways that enhance the user experience, sustain an adequate quality of service under high traffic loads, and improve network efficiency. Such networks would ideally provide media content that is highly personalized and formatted relative to delivery mode, location, and the client device.

### SUMMARY OF THE INVENTION

These and other problems are addressed by providing on-the-fly content processing and customization at the network edge close to the end user. For example, in the same manner a CDN enhances availability and delivery of content while reducing bandwidth costs and loads on the network backbone, aspects of the disclosure provide for content processing (such as transcoding, formatting, aggregation, etc.) at the edge nodes, thus reducing loads on the core network and the content provider's origin infrastructure. For example, application-specific functions, such as adapting client requests and customizing content delivery to the clients, may be performed at the edge servers.

In some aspects, client requests for content are intercepted at an edge node. The request may be edited to customize the content for the user and/or the client device. In one aspect, the client request is edited to modify the requested content format to ensure that the delivered content is suitable for ingestion by the destination client device. In another aspect, the client request is modified to request a content format that is more suitable for current network conditions, such as to match the content size or bandwidth to the client's available link bandwidth, to reduce local demands on the network, and/or to provide a predetermined quality of service to the client.

In some aspects of the disclosure, media content addressed to a client is intercepted at an edge node. The content may be filtered, edited, transcoded, or otherwise modified before being routed to the client device. In one aspect, the edge node customizes the content for the user and/or the client device. In some aspects, the system distinguishes between the destination client device and a client functioning as a proxy for the destination client device. In such aspects, the content format may be modified to ensure that the delivered content is suitable for ingestion by the destination client device. In another aspect, the content format is adapted to improve suitability for current network conditions, such as to match the content format to the client's available link bandwidth, to reduce local demands on the network, and/or to provide a predetermined quality of service to the client.

In one aspect, a method for routing media over a content delivery network, comprises intercepting a media transmission en-route to a client device, analyzing the media transmission; retrieving at least one of a client profile and a user profile associated with the client device; determining from the media transmission (e.g., the media content format and/or metadata) and the client profile if one or more processes are to be performed on the media before routing the media to the client; and performing the one or more processes on the media when it is determined that the one or more processes are to be performed.

Aspects of the disclosure differ from service-oriented architectures in that such implementations are not burdened with the overhead of message-oriented middleware, which requires software elements in all communicating components of a client/server architecture. Unlike middleware implementations, such aspects employ a CDN architecture, which permits clients to pass requests directly to a potential server instead of requiring every client to direct its requests through a middleware service broker. Furthermore, aspects of the disclosure can account for network topology when selecting a server or process, as these aspects are configured to optimize network performance and/or cost.

Some aspects provide for selecting a process that reduces network load while maintaining the client's quality of service. For example, server backlogs may provide a basis in a decision process for selecting servers or other hardware for processing media en-route to a client device.

In some aspects of the disclosure, a CDN comprises a content-delivery infrastructure, a request-routing mechanism, and a distribution mechanism. The content-delivery infrastructure comprises a network of geographically-distributed content delivery nodes that are arranged for efficient delivery of media content on behalf of third party content providers. The content delivery infrastructure usually comprises a set of “surrogate” origin servers (e.g., edge servers) that are located at strategic locations (e.g., Internet network access points, Internet Points of Presence, and the like) for delivering content to requesting end users. The request-routing mechanism allocates servers in the content delivery infrastructure to requesting clients in a way that, for web content delivery, minimizes a given client's response time and, for streaming media delivery, provides for the highest quality.

In one aspect of the disclosure, the request routing mechanism is configured to intercept and evaluate a client request en-route to a server. In such instances, this may be performed by an edge node. The request routing mechanism may modify the request, if necessary, to personalize the media content, to specify formatting that ensures the media content is suitable for ingestion at the client device, and/or improve network performance.

The distribution mechanism includes on-demand or push-based mechanisms that move content from the origin server to the surrogates. In another aspect of the disclosure, the distribution mechanism is configured for intercepting media en-route to a requesting client and modifying the media, if necessary, to personalize the media content, select the media format so the media is suitable for ingestion by the client device, and/or adapt the media format and/or content to improve network performance.

The request-routing mechanism and the distribution mechanism include methods, systems, and computer-readable media comprising program code that may be used for managing hierarchical data collection, analysis, and decision support for efficiently distributing media content to a plurality of clients.

### BRIEF DESCRIPTION OF THE DRAWINGS

Some aspects of the disclosure are illustrated in the figures of the accompanying drawings which are meant to be exemplary and not limiting, in which like references are intended to refer to like or corresponding parts, and wherein:

FIG. 1 is a network topology diagram of a hierarchical caching network according to one aspect of the disclosure;

FIG. 2 is a flow diagram depicting a method for routing requests for network resources in a CDN;

FIG. 3 is a flow diagram depicting a method for processing requests for media content as the requests are routed in a CDN;

FIG. 4 is a flow diagram depicting a method for processing media format as the media is routed in a CDN;

FIG. 5 is a block diagram of an edge server in a CDN configured in accordance with aspects of the disclosure;

FIG. 6 is a flow diagram of a method for analyzing and adapting requests for media in accordance with aspects of the disclosure; and

FIG. 7 is a flow diagram of a method for intercepting and processing media en-route to a client device;

### DETAILED DESCRIPTION

In the following description, reference is made to the accompanying drawings that form a part hereof, and in which is shown by way of illustration specific aspects in which the invention may be practiced. It is to be understood that other aspects and embodiments may be utilized, and structural changes may be made without departing from the scope of the invention.

As used herein, a media object includes, without limitation, an audio file (such as, e.g., an MP3 (Motion Picture Experts Group-1 Layer 3) file and a RealNetworks, Inc. Real format file), a video file (such as an MPEG file), an image file (such as, e.g., a BMP (bitmap) file or JPEG (Joint Photographic Experts) file) and any other software or data file or object.

A parent server (or parent site or parent server site) may comprise one parent server or a cluster of parent servers. Likewise, an edge server (or an edge site or edge server site) may comprise one edge server or a cluster of edge servers, and an origin server (or an origin server site or origin site) may comprise one origin server or a cluster of origin servers. The CDN may be configured such that servers in a cluster share a common storage. However, aspects of the invention may use a variety of different network configurations.

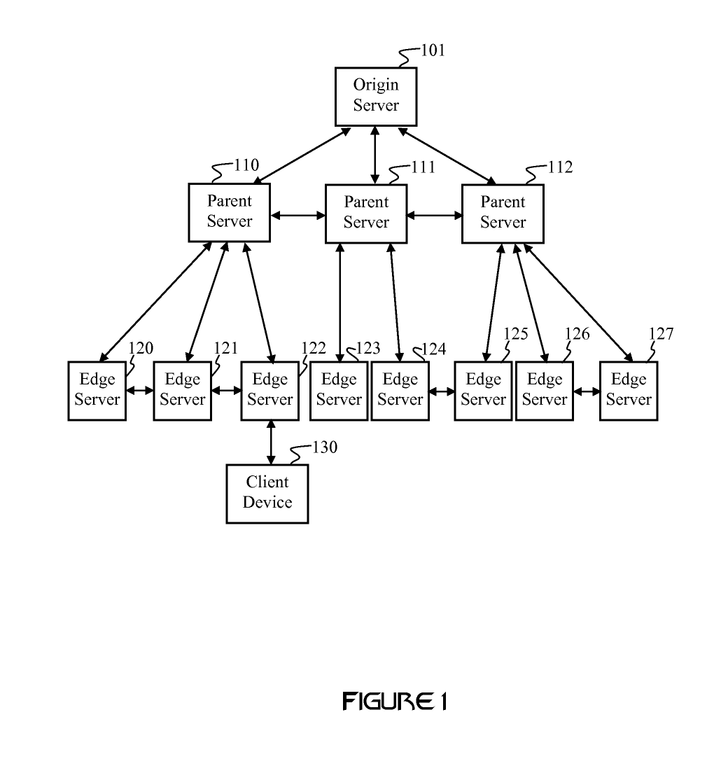

FIG. 1 is a network topology diagram of a hierarchical caching network. A top-level cache comprises one or more origin servers, such as origin server 101. A mid-level cache comprises multiple parent servers 110-112 communicatively coupled to the origin server 101. A bottom-level cache comprises multiple edge servers 120-127. Each edge server 120-127 is communicatively coupled to at least one of the parent servers 110-112.

In one aspect, a client device 130 transmits a request for content to an edge cache server 122. This content request is directed to the corresponding bottom level server 122 based on the location of the requesting client 130. Upon receiving the request, the edge server 122 either returns the corresponding content if it is locally available, or routes the request to other cache servers in the hierarchy. Content requests are possibly routed to directly-connected bottom level edge servers (e.g., edge server 121) or to a mid-level parent server (e.g., parent server 110). Similar actions are performed at the mid-level server 110, which either returns the corresponding content or routes the request to other cache servers via dynamic request routing. Requests can be directed to other bottom-level edge-server nodes 120, 121, and/or 123-127 to satisfy the downstream content requests, or to neighboring parent servers 111 and/or 112 at the middle level. A “last resort” option is to route the request to a top level origin server 101, which is the source content server that stores all available contents in the entire network. Content requests will eventually be served or rejected given the constraints on content availability and link capacities.

Storage and routing decisions are typically based on user request patterns, cache sizes, link capacities and the system topology. In some aspects, storage and routing decisions are performed to maximize the number of supported requests and/or maximize the amount of bandwidth the network serves to clients.

In a typical CDN, the parent servers 110-112 and edge servers 120-127 are maintained by a network provider, wherein the parent servers 110-112 are primarily used for storing and managing one or more media objects, and edge servers 120-127 are primarily used for serving the media objects to clients 130. End-users or client proxies that access these media objects are referred to as clients 130.

In some aspects, all the media objects are retrieved from origin servers 101 and stored on one or more parent servers 110-112 before the client 130 can access each such object. Accordingly, in these aspects, the origin servers 101 play no significant role in object replication and delivery except to supply new and/or updated objects for storage on the parent servers 110-112. Moreover, only the parent servers 110-112 communicate with the origin servers 101. In other aspects, each requested object is replicated from one or more origin servers 101 to one or more parent servers 110-112 (and/or one or more edge servers 120-127) when the requested object becomes popular. In these aspects, the origin servers 101 play a more significant role in object replication and delivery to supply objects to parent servers 110-112 and/or edge servers 120-127 when requested. So, in these aspects, the origin servers 101 and parent servers 110-112 communicate with each other, and the origin servers 110-112 and clients 130 may also communicate with each other. In all of these aspects, the communications relationships between origin servers 101 and parent servers 110-112 may be one-to-one, one-to-many, or many-to-many.

As shown in FIG. 1, the parent servers 110-112 and edge servers 120-127 communicate with each other, and the edge servers 120-127 and clients 130 communicate with each other. In some aspects of the invention, the parent servers 110-112 and clients 130 may communicate with each other. Typically, the edge servers 120-127 act as the primary source for serving objects. However, if a requested object is not available at the edge server 120-127, a parent server 110-112 may serve the requested object to the clients. Also, FIG. 1 shows a single layer or level of parent servers 110-112 and a single layer or level of origin servers 101. As will be apparent to those skilled in the art, more than one layer or level of parent servers 110-112 and/or origin servers 101 may be employed.

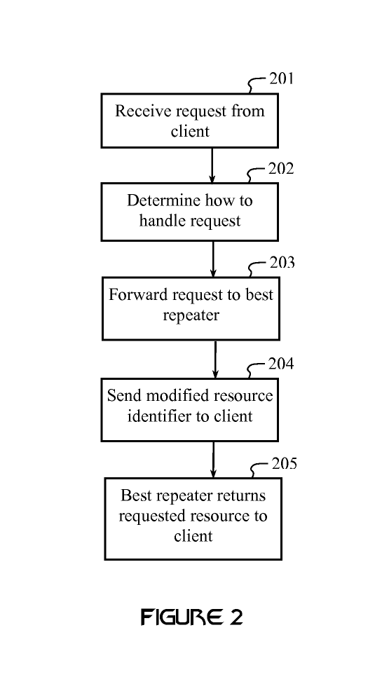

In accordance with an aspect of the disclosure, FIG. 2 is a flow diagram depicting a method for routing requests for network resources in a CDN. A server receives a request for content from a client 201. The request includes a resource identifier for the particular resource. Sometimes the resource identifier includes an indication of the origin server. A mechanism known as a reflector, which may be co-located with the origin server, determines how to handle the request 202 from the client. For example, the reflector may decide whether to reflect the request or to handle it locally. The reflector may determine a “best” repeater to process the request and forwards the request to the selected repeater 203. If the request is reflected, the reflector may send a modified resource identifier to the client 204 that designates the selected repeater. Then, the client requests the resource from the repeater designated in the modified resource identifier (not shown), and the repeater responds to the client's request by returning the requested resource to the client 205. If the repeater has a local copy of the resource, it returns that copy. Otherwise, it forwards the request to the origin server or to another repeater to obtain the resource. Optionally, the repeater may save a local copy of the resource in order to serve subsequent requests.

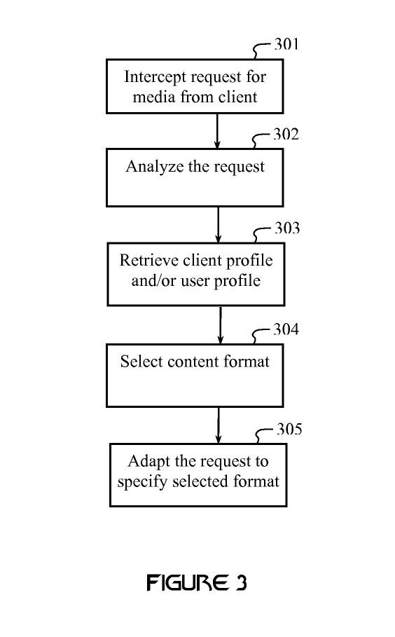

FIG. 3 is a flow diagram depicting a method for processing requests for media content as the requests are routed in a CDN. The flow diagram comprises the steps of intercepting a request for media content made by a client device 301, analyzing the request 302, retrieving client profile data and/or user profile data associated with the client device 303, selecting media content format based on the request and the client and/or user profile data 304, and adapting the request to include the selected content 305 before routing the request to the server.

When a client makes a request for an object from the CDN, an optimal, or “best,” edge-based content server is typically identified. The client browser then makes a request for the content from that server. If the requested object is not available at the identified server, the object may be retrieved from another CDN content server or, failing that, from the origin server. Thus, there are several instances in which aspects of the invention may provide for intercepting the request for media 301. In one aspect of the invention, step 301 may comprise intercepting a request for content sent by an edge server to another CDN server or the origin server. This request may be made on behalf of the client, or the request may be made by the edge server in anticipation of serving requests for popular media content.

Steps 302 and 303 may be performed in any order. In some aspects, the steps 302 and 303 may be performed simultaneously. In steps 302 and 303, the nature of the requested media is compared to information about the client device and/or information about the user. For example, information about the client device (e.g., its presentation capabilities, operating system, software, and/or link bandwidth) may be used to determine an appropriate or preferred format for the requested media.

The content may need to be transcoded into an appropriate video format based on the type of client device receiving the content. Such transcoding may include formats for consumption by legacy set-top boxes, formats for use on personal computers, as well as formats for use by smart phones and other portable media devices. Alternative formats may be employed, the foregoing being merely illustrative.

Other factors, such as network congestion, network outages, and queue backlogs may be used to determine a more suitable format, such as to improve network performance and/or ensure a predetermined level of quality of service to the user.

In one aspect of the invention, steps 302 and 303 comprise analyzing the request in view of a user profile, which may include user preferences, demographic data, geographic data, history, subscription information, and/or the like. Such user information may be used to personalize or customize the requested media. In some aspects, the request may be modified to select additional media and/or services in step 304. For example, stock quotes, local weather, and/or predetermined news feeds may be denoted in the format. In some aspects, the format may comprise a watermark or customized advertisements. In some aspects, the format may denote a predetermined quality of service, such as a quality of service based on a user's subscription. Selecting the content format 304 may also include editing or appending metadata associated with the content.

Since content residing at a server may be automatically transcoded, transrated, and/or re-encoded according to a predetermined set of formats, such as formats that are most often requested or used by requesting devices, step 305 may comprise adapting the request routing, such as to redirect the request to a server capable of providing the requested content in the appropriate format.

In some aspects of the invention, selecting the content format 304 may comprise determining which transcoding operations to perform on the requested media. This may require identifying available transcoding hardware and redirecting the request (such as in step 305) to a server that can perform the necessary transcoding.

In one aspect of the invention, the method depicted in FIG. 3 is performed prior to step 201 in FIG. 2. For example, an edge server that first receives the client request may perform the steps in FIG. 3. In another aspect of the invention, the server recited in step 201 is an edge server, and the method of FIG. 3 is performed by the server before the reflector determines how to handle the request in step 202. In another aspect of the invention, the reflector resides on an edge server, and the method of FIG. 3 is performed in step 202. In another aspect of the invention, the method of FIG. 3 is performed in step 203 and may comprise a routing operation in which the request is forwarded to the selected repeater. In another aspect, the method of FIG. 3 is performed when a client request with the modified resource identifier is routed to the selected repeater prior to the selected repeater responding to the client request in step 205.

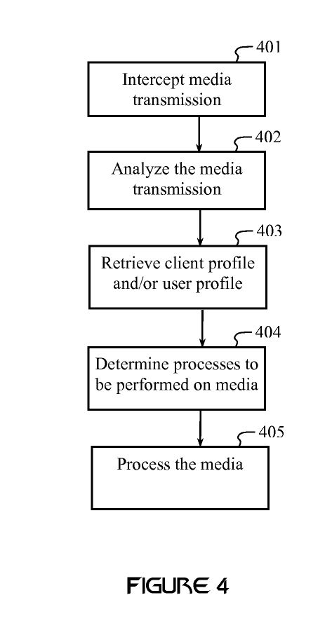

In some aspects of the invention, an edge server that processes a client request may retrieve requested media from another edge server, a parent server, or an origin server. During the process of requesting media from another server, the edge server may adapt this request in accordance with the method depicted in FIG. 3. In some aspects of the invention, media delivered in the aforementioned process may be intercepted and processed in accordance with the method depicted in FIG. 4.

FIG. 4 is a flow diagram depicting a method for processing media format as the media is routed in a CDN. The flow diagram comprises the steps of intercepting a media transmission addressed to a client device or CDN server 401, analyzing the media 402, retrieving client profile data and/or user profile data associated with a client device requesting the media 403, determining processes to be performed on the media before delivery to the client 404, the processes being based upon the media format and the client and/or user profile data, and processing the media 405, if necessary, before routing the media to the client.

In aspects of the invention, the method depicted in FIG. 4 may be performed as part of step 205 in FIG. 2. The step of intercepting the media transmission 401 may be performed as part of a routing procedure during which media en-route to a client device is intercepted. Alternatively, step 401 may comprise intercepting media en-route to a server that will eventually be delivered to a client. In both of these aspects, the media is intercepted 401 by an edge server.

Steps 402 and 403 may be performed in any order and may be performed simultaneously. Step 402 may comprise directly determining media format, such as measuring properties of the media. In some aspects, step 402 may comprise retrieving metadata associated with the media that indicates the media format (e.g., encoding, compression, encryption, resolution, bandwidth, frame rate, etc.).

The media content may be analyzed with respect to a user profile, which may include user preferences, demographic data, geographic data, history, subscription information, and/or the like. Such user information may be used to personalize or customize the media content and/or format. As a result of the analysis 402, the media content may be modified to include additional content and/or services. For example, stock quotes, local weather, and/or predetermined news feeds may be denoted in the processes to be performed on the media 404. In some aspects, the media format and/or content may be processed 405 to include a watermark or customized advertisements. In some aspects, the media may be processed 405 to provide a format related to a predetermined quality of service, such as a quality of service based on a user's subscription. Determining the processes 404 may comprise editing or appending metadata associated with the content.

Since content residing at a server may be automatically transcoded, transrated, and/or re-encoded according to a predetermined set of formats, such as formats that are most often requested or used by requesting devices, step 405 may comprise routing the media to a server capable of performing the processes determined in step 404.

For example, step 404 may comprise determining which transcoding operations to perform on the media. This may require identifying available transcoding hardware and redirecting the media (which would be performed in step 405) to a server that can perform the appropriate transcoding. Selection of servers and/or other hardware to perform the operations in step 405 may comprise determining a “best” server and/or hardware component relative to performance and/or cost. Thus, queue backlogs, network congestion, geographical proximity, number of hops in a communication link, and/or other factors that may delay delivery of the media may be considered when selecting the best server or hardware component. Costs associated with leasing hardware, other processing resources, and/or network bandwidth may be considered when determining the best server or hardware component.

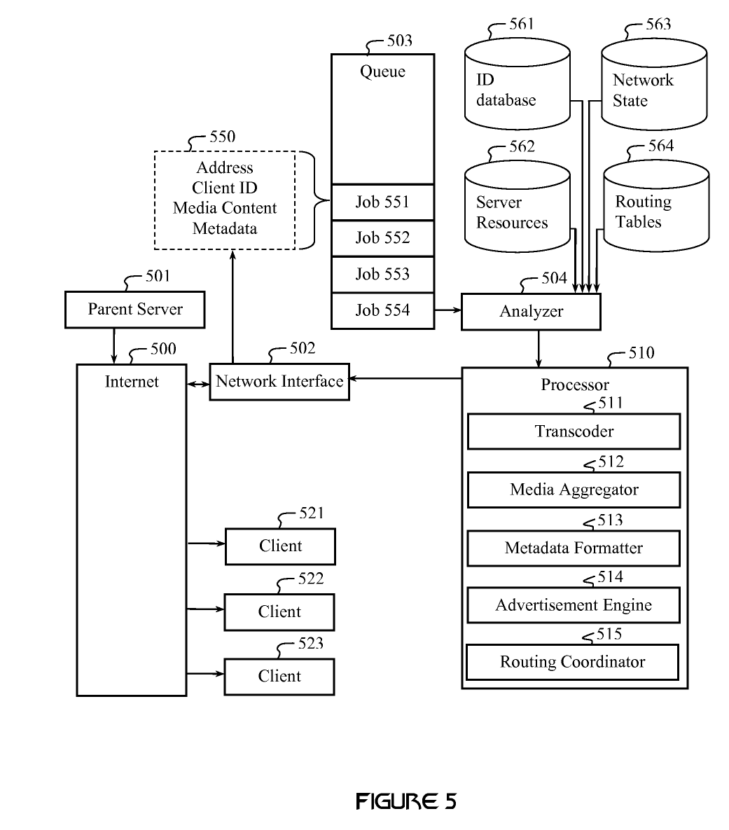

FIG. 5 is a block diagram of an edge server in a CDN configured in accordance with aspects of the invention. The edge server is part of a content delivery service that distributes media content to client devices 521-523 over the Internet 500 or a similar network. Media content distributed by such services may include television programs, movies, other audio/visual content, audio content and the like that are obtained from one or more sources, such as a parent server 501, an origin server (not shown) or other edge servers (not shown). Typically, clients 521-523 connect to the media distribution service using a conventional web browser or other client program to obtain streaming or file-based media content.

In various aspects, client devices 521-523 may include desktop or notebook computers, mobile telephones, personal digital assistants, video game players, portable media players, and/or any other devices capable of receiving and/or rendering the content.

To receive a desired media service or file, a user of a client device 521-523 typically contacts a network host using a conventional browser or the like. The user identifies the desired content by providing search criteria, navigating a user interface, and/or other techniques. In various aspects, the host is able to search metadata associated with available media to allow users to search for content based upon title, network, actor/actress names, genre, and/or any other search criteria. After the user selects desired content, the host may provide the selected content to the client device 521-523 directly or via one or more servers of the CDN using any sort of streaming, file-based or other delivery techniques.

The edge server comprises a network interface 502, a queue 503, an analyzer 504, and a processor 510. The edge server receives the media content via the network interface 502 addressed to a client 521-523 from one or more sources (e.g., parent server 501), determines if the media content requires processing, and processes the media content (or routes the content for processing by another server) before routing it to the client 521-523. The edge server may be any conventional computing system capable of manually and/or automatically receiving media content via any transport technique, including pushed or pulled file transfer protocol (FTP), pushed or pulled trivial file transfer protocol (TFTP), hypertext transport protocol (HTTP), really simple syndication (RSS) or other automated syndication, or the like.

With reference to FIG. 5, the project queue 503 supports any number of active jobs 551-554, each of which is associated with a received media content data structure 550 addressed to a particular client (i.e., a message). The messages are received at a network interface 502 (e.g., a transceiver) from the parent server 501, another edge server (not shown), an origin server (not shown), and/or any other sources and passed to the queue 503. Each message has a message format 550 comprising a client address, client identifier information (optional), media content, and (optionally) metadata. Each job 551-554 is assigned (e.g., by control logic) to the server for analysis and processing. In various aspects, the number of servers in use at any particular time may depend upon the current utilization of the queue 503. Accordingly, jobs may be outsourced to other servers.

The queue 503 comprises any structure or service capable of maintaining jobs 551-554 in an orderly fashion. In various aspects, the queue 503 is a logical structure that is arranged for parallel processing, first-in-first-out (FIFO) processing, last-in-first-out (LIFO) processing, or any other processing scheme as desired. The queue 503 may be implemented using any sort of queue, stack, array or other structure, or any service capable of providing queuing and/or the like. In some aspects, the queue 503 may be physically provided on any sort of cloud service or on any locally- or remotely-located hardware.

The exemplary server shown in FIG. 5 includes an analyzer 504 component for analyzing the message in each job 551-554 retrieved from the queue 503. The analyzer 504 may analyze media content and/or determine from the metadata the media format, including encoding, compression, sampling frequency, bit rate, resolution, file format, and the like. The analyzer 504 may determine if the media format is suitable for ingestion by the client device and/or optimal for delivery over the network relative to quality of service at the client device and network loads.

The analyzer 504 may analyze a message with respect to data stored in memory on the server, such as an identity database 561, a server resources database 562, a network state database 563, and/or a routing table or routing policy database 564. For example, client identity data may be employed for determining the identity of the user and retrieving user preferences, subscription information, behavior, history, and other user metrics. The client identity data may include the operating specifications of the client device, such as the device's media presentation capabilities and information about the operating system and software running on the device. Server resources data may comprise a menu of available media files and media processing resources available on the edge server as well as on other edge servers. The server resources data may include a measure of demand for media resources on the other servers. The analyzer 504 may use the server resources data for selecting alternate servers for processing the media content if such processing capabilities are unavailable or highly loaded on the current server. The network state data may comprise network load information and queue backlogs for selecting one or more alternate servers to optimize performance and/or cost.

Various aspects of the processor 510 may be implemented using dedicated or shared hardware servers. Alternative implementations may employ virtual server features, such as part of a cloud computing service.

The processor 510 comprises a transcoder component 511 configured for encoding (or transcoding) content from a set of predetermined input formats to any of a set of predetermined output formats. A job that includes media content received from the parent server 501 in a particular format (e.g., MPEG-4), for example, may be encoded or transcoded to a different format (e.g., Windows Media or H.264). The transcoder 511 is typically configured to support different formats, bit rates, and/or other parameters.

In one aspect, the processor 510 comprises a media aggregator 512 configured for aggregating content for delivery to the client. For example, user preferences for a particular type of media content may indicate secondary media streams be aggregated with a primary media stream for delivery to the client device. The aggregator 512 may add or edit media content that is pertinent to a user's geographical location, subscription status, or other user- or device-specific criteria. In some aspects, the media aggregator 512 works in cooperation with an advertisement engine 514, such as to deliver user-relevant ads.

The processor 510 may comprise a metadata formatter 513 configured for adding, editing, and/or formatting metadata associated with the content. Metadata about the received content may be obtained from various sources and filtered, edited, and/or combined. In various aspects, metadata is obtained from content sources with the delivered media content itself. Alternatively, metadata may be obtained from online sources that may or may not be associated with the content provider. Thus, metadata formatter 513 may include a web-based or other networked source of information. Additional metadata for particular media content may be obtained even when metadata is provided from the content source. Furthermore, the metadata formatter 513 may update metadata about the content format, such as when the format is changed by the transcoder 511, and/or additional content is inserted by the media aggregator 512.

The processor 510 comprises a routing coordinator 515, which reads the address information in each packet to determine its ultimate destination. Then, using information in its routing table or routing policy, it directs the packet to the next network device via the network interface 502. In some aspects, the analyzer 504 may determine that one or more processing functions, such as transcoder 511 processing and/or media aggregator 512 processing, be performed on a different server. In such aspects, the routing coordinator 515 routes the message to the appropriate server(s).

Edge servers receive mapped requests from clients (e.g., clients 521-523) and deliver the requested media content to the client 521-523. The edge servers are part of a CDN's distribution system and support the activity of moving a publisher's content from origin servers to one or more surrogate servers. Distribution proceeds when an edge server anticipates or receives a client request. The distribution system also communicates content signals, which specify control information, such as validation and expiration of the content. The CDN uses these content signals to maintain the integrity and consistency of the content in its edge servers. The distribution system interacts with the CDN's request-routing system to provide content availability information about the edge servers. The distribution system may also interact with other systems to monitor the volume of content distribution.

The request-routing system directs each client request to an optimal edge server. Multiple edge servers may cooperate to direct a request and may use dynamic information about network loads and server queue backlogs when directing requests. The request-routing system interacts with the distribution system to convey the demand for content, which the distribution system uses to place the content into the edge servers.

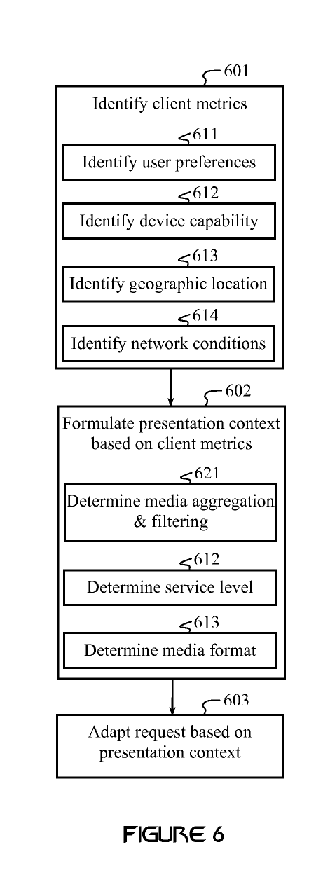

FIG. 6 is a flow diagram of a method for analyzing and adapting requests for media in accordance with aspects of the invention. In one aspect, the analyzer 504 in FIG. 5 identifies client metrics 601 and formulates a presentation context 602 based on the identified client metrics. The routing coordinator 515 in the processor 510 adapts the request based on the presentation context 603.

The analyzer 504 identifies the client metrics 601, typically via a combination of analyzing the request and retrieving data stored in memory on the server. For example, the analyzer 504 may identify user preferences 611 and device capability 612 by retrieving data from the identity database 561. The user's geographical location may be determined 613 via any number of techniques, including analyzing routing information in the request and retrieving data, such as from the server resources database 562, the network state database 563, and/or the routing policy database 564. The analyzer 504 may identify network conditions 614 that are local to the client, network conditions that are relevant to routing requests to one or more servers, and/or network conditions that are relevant to routing requested media to other servers for processing and/or to the client.

The analyzer 504 formulates the presentation context of the requested media 602 based on the client metrics determined in step 601. For example, media aggregation and/or filtering may be determined 621 to provide the user with a personalized media presentation. The service level of the media to be delivered may be determined 622 based on user preferences, client device type, network conditions, and/or subscription level. The media format may be determined 623 based on the client device type, network conditions, and/or other factors.

Once the presentation context is determined 602, the processor 510 adapts the request 603 in accordance with the presentation context. For example, the request may be adapted 603 to specify a particular media format. In some aspects, a particular request for media may spawn requests for supplemental media to accompany the requested media. In some aspects, the request may be routed to a different server that is better equipped to process and/or deliver the requested media according to the presentation context.

CDNs often receive content from any number of different production sources, syndicators, web-based services and other media sources. Often, each content source has its own set of techniques and formats for delivering new material. Media files may be delivered, for example, using any number of different transport techniques and channels. The media may be delivered in any number of different compressed and/or uncompressed formats that may be transcoded or otherwise converted before the content is made available for distribution to users. Furthermore, as users employ an increasing variety of client devices (e.g., mobile phones, tablets, laptops, video game players, and other portable devices), it can be advantageous to encode/transcode distributed content into any number of different distribution formats (e.g., different formats, and/or other files of different sizes, bit rates, frame rates, resolutions and/or other parameters) to accommodate a variety of viewers and viewing devices. Thus, the number of transcoding processes and other processes that may be performed on the content prior to distribution can be significant.

Typically, the large volume of content received by CDN nodes (e.g., edge servers and parent servers), the high frequency of content delivery, the wide variety of media formats required, and the need to make content available quickly often makes formatting the media before delivery impractical, or at least undesirable in many implementations. Thus, some aspects of the invention provide for media processing on the fly.

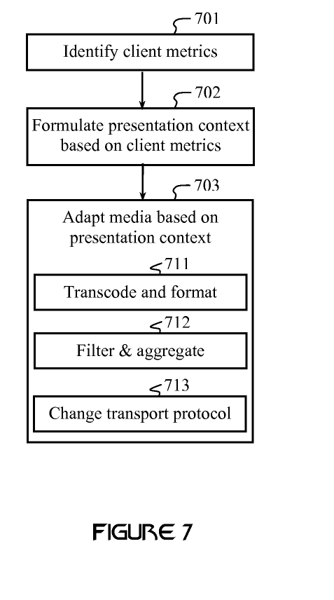

FIG. 7 is a flow diagram of a method for intercepting and processing media en-route to a client device. In one aspect, the analyzer 504 in FIG. 5 identifies client metrics 701 and formulates a presentation context 702 based on the identified client metrics. The processor 510 adapts the media based on the presentation context 703. The step of adapting the media 703 may comprise at least one of a set of steps, including transcoding and formatting the media 711, filtering and aggregating media 712, and changing the transport protocol 713.

In one aspect, the media may be adapted to any number of different compressed and/or uncompressed formats that may be transcoded or otherwise converted before the content is delivered to the user. For example, adapting the media 703 may comprise encoding/transcoding media content into any number of different distribution formats, including files of different sizes, bit rates, frame rates, resolutions, and/or other parameters) to accommodate the specific client device.

In one aspect of the invention, transcoding and/or formatting 711 may be performed by the transcoder 511 and/or the formatter 513. In another aspect of the invention, the processor routes the media via the routing coordinator 515 to another server for transcoding and/or formatting. The other server may be selected minimize latency, provide for network load balancing, or otherwise enhance performance and/or reduce cost. The transcoded and/or formatted media may be returned to the processor 510 or forwarded to the requesting client 521-523. In some aspects, formatting 711 may comprise formatting metadata, which may be performed by the metadata formatter 513.

Media content may be filtered and/or aggregated 712 based on user preferences, subscription level, device capabilities, and/or other client metrics. In one aspect of the invention, the media aggregator 512 and/or the advertisement engine 514 performs the filtering and/or aggregating 712.

Media files may be delivered, for example, using any number of different transport techniques and channels. In some aspects, the routing coordinator 515 is configured for changing the transport protocol 713.

Although the flow diagrams may describe operations as a sequential process, many of the operations can be performed in parallel or concurrently. In addition, the order of the operations may be re-arranged. A process is terminated when its operations are completed, but could have additional steps not included in the figures. A process may correspond to a method, a function, a procedure, a subroutine, a subprogram, etc. When a process corresponds to a function, its termination corresponds to a return of the function to the calling function or the main function.

The Figures are conceptual illustrations allowing for an explanation of the present invention. It should be understood that various aspects of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant arts.

1. A method for routing media over a content delivery network (CDN), comprising:
at an edge node in the CDN, intercepting a media transmission en-route to a client device;
determining from the media transmission and a client profile if one or more processes are to be performed on the media to provide a customized content format; and
performing the one or more processes on the media before routing the media to the client device.

2. The method recited in claim 1, wherein the content format specifies at least one of a filtered, aggregate, edited, coded, and encrypted format.

3. The method recited in claim 1, wherein the content format is selected to ensure that delivered content is suitable for ingestion by the destination client device.

4. The method recited in claim 1, wherein determining comprises optimizing a combination of network performance and cost.

5. The method recited in claim 1, wherein determining comprises determining the ability of the client device to ingest the media based on at least one of a set of device specifications, the set comprising media display capability, processing capability, presentation software information, subscription information, network load, and user preferences.

6. The method recited in claim 1, wherein determining comprises at least one of analyzing metadata in the media transmission and measuring properties of the media transmission.

7. The method recited in claim 1, wherein the one or more processes comprises at least one of a set, the set comprising re-sampling, re-encoding, aggregating content, watermarking, and translating.

8. The method recited in claim 1, wherein performing comprises rerouting the media transmission for processing at a different server.

9. The method recited in claim 8, wherein the different server is selected to minimize at least one of a set of network performance metrics, the set comprising delay, queue backlog, and minimize cost.

10. An edge server configured for performing the method recited in claim 1.

11. A computer program residing on one or more non-transitory computer-readable media configured for performing the method recited in claim 1.

12. A method for routing messages over a content delivery network (CDN), comprising:
at an edge node in the CDN, intercepting a request for media content from a client device;
determining a customized content format based on the request and a client profile for at least one of the client device and the user; and
adapting the request to specify the content format before routing the request.

13. The method recited in claim 12, wherein the content format specifies at least one of a filtered, edited, coded, and encrypted format.

14. The method recited in claim 12, wherein the content format is selected to ensure that delivered content is suitable for ingestion by the destination client device.

15. The method recited in claim 12, wherein determining comprises optimizing a combination of network performance and cost.

16. The method recited in claim 12, wherein determining comprises determining the ability of the client device to ingest the media based on at least one of a set of device specifications, the set comprising media display capability, processing capability, presentation software information, subscription information, network load, and user preferences.

17. The method recited in claim 12, wherein adapting the request comprises rerouting the request for processing at a different server.

18. The method recited in claim 17, wherein the different server is selected to minimize at least one of a set of network performance metrics, the set comprising delay, queue backlog, and minimize cost.

19. An edge server configured for performing the method recited in claim 12.

20. A computer program residing on one or more non-transitory computer-readable media configured for performing the method recited in claim 12.
